(19) United States
(12) Patent Application Publication
(10) Pub. No.: US 2013/0108355 A1
(43) Pub. Date: May 2, 2013

(54) JOINT DEVICE FOR RODS AND PANELS

(71) Applicant: JOHN T.S. LEE, Gaithersburg, MD (US)

(72) Inventor: JOHN T.S. LEE, Gaithersburg, MD (US)

(21) Appl. No.: 13/283,925

(22) Filed: Oct. 28, 2011

(51) Int. Cl. F16D 1/00

(52) U.S. Cl. 403/171

(57) ABSTRACT

Box shaped device for joining cylindrical rods and flat panels having multiple orthogonal holes on three axis allows quick joint of two or more rods or panels or combination thereof in two or three axis. The holes are threaded to allow screws to lock the rods or panels in position. The rods being slightly smaller than the size of the holes, can be inserted thru the holes and locked at any position, allowing flexibility to construct any frame structure of any size, and do not require rods or panels with specially shaped attachment points. Special purpose blocks can be made with holes at different angles or special shapes for mounting panels etc.

### FIELD OF THE INVENTION

The present invention relates to joints for connecting a combination of cylindrical rods and panels for building space frame.

### BACKGROUND OF THE OF INVENTION

The present invention relates to connecting hub for rods and panels.
Currently there are many methods for connecting rods to construct frame structures; most of these require special interfacing between the rods and the connector. As such usually the rods are of made to a number of standard lengths, and have specific shaped ends to interface with specific connecting blocks, limiting the ability to build structure of non-standard sizes.
Usually these connectors are at the end of the rods, terminating the rods. None of these systems allows joining both rods and panels in three axis in any combinations.

### SUMMARY OF THE OF INVENTION

The present invention allows rods and panels to be used in construction of a space frame using just one type of joint device; the only requirement is that the rod diameter has to match the size of the holes on the connecting hub. The device may be positioned anywhere along the rods, allowing flexibility in design, and the rods can be fixed by using set screw in a hole perpendicular to the rod. Panels can be screwed into any of the available holes.
Specially shaped accessory connector can also be provided to serve other functions, such as panel holder, hanger, etc. The system can scaled up or down to be used as construction toys, engineering models, temporary structures, or permanent structures. The availability of composite rods such as carbon fiber rods, are ideal for most application, they are stronger than steel by weight and will not bend permanently, if flexed, it will flex back to its original shape.

For low strength application the hub can be made of plastic or composites such as ABS, polycarbonate, acetal, etc., for medium to high strength application, they can be made of metals, such as aluminum, brass, steel etc. For medium to high strength application, the rods can be locked to the hub using set screws, while for low strength application the rods can be locked to the hub by using glue or set screws.

### BRIEF DESCRIPTION OF THE DRAWINGS

FIG. 1. shows typical three axis rod joints

FIG. 2. shows cutaway drawing, showing the three rods do not intersect each other.

FIG. 3. shows typical three axis rod joints with set screws to lock the rods in place

FIG. 4. shows typical application

FIG. 5. shows sample of combination of panels and rods joints.

FIG. 6. shows a sample of angular construction

### DETAILED DESCRIPTION OF THE INVENTION

For most application, a simple hi-performance plastic square block drilled with 2×2 matrix of holes (one near each corner) on each axis is sufficient. For more flexibility, 5 holes, 4 in the corners and one in the center, and for the most flexibility, 3×3 matrix provides almost endless possibilities. In these examples, the blocks are made of 0.75″ DELRIN cubes with 0.188″ thru holes, 0.186″ carbon fiber rods, and # 10-32 set screws.

For application requiring strength, bigger joint device can be made of higher strength materials such as aluminum or steel. The device can also be scaled up or down to meet specific requirements.

In combination with carbon fiber rods, the system makes a very strong structure.

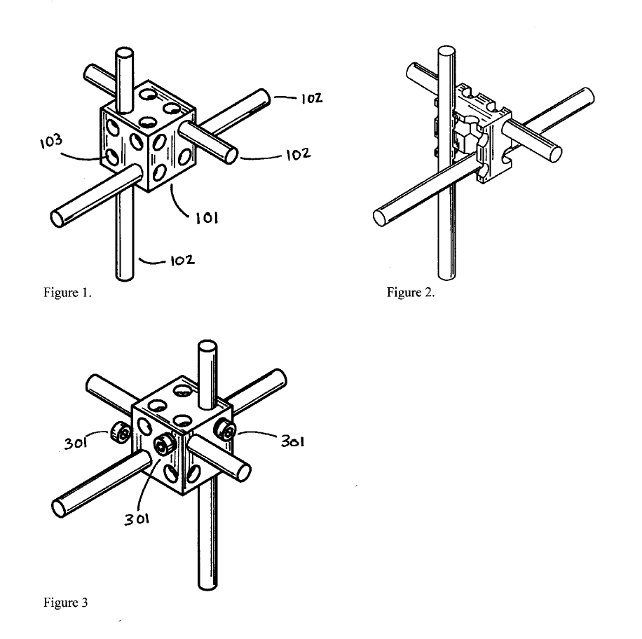

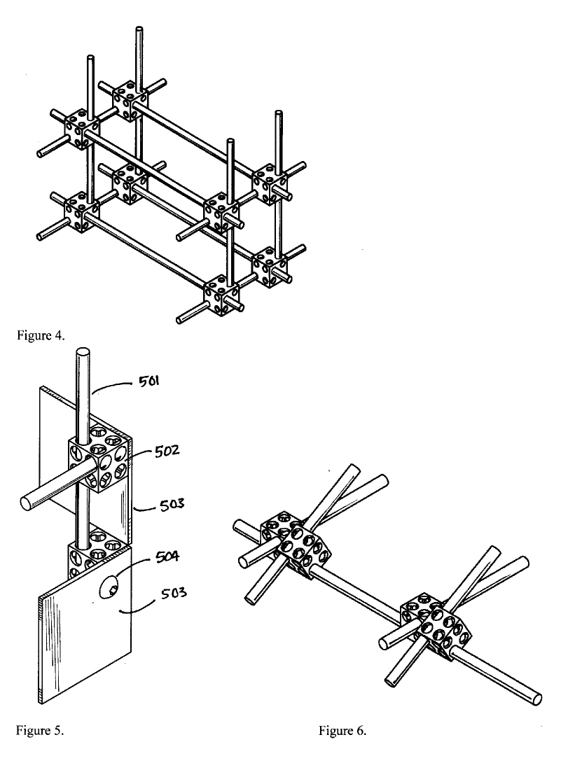

FIG. 1. illustrates a 3 rod joints without intersecting each other. The joint device 101 having four holes on each axis with rods 102 inserted thru holes 103 in different quadrant on each axis.

FIG. 2. is a cutaway drawings showing the 3 rods in their own axis quadrant, not intersecting each other.

FIG. 3. illustrates positions of set screws 301, to lock the rods in place.

FIG. 5. illustrates the device 502 used to joint rods 501 with panels 503 using panel screw 504.

FIG. 6. illustrates the device used to create angular arrangement.

### LIST OF PRIOR ART

U.S. Pat. No. 810,148—Frank Hoenby
U.S. Pat. No. 2,682,235—R. B. Fuller
U.S. Pat. No. 2,709,318—T. S. Benjamin
U.S. Pat. No. 3,286,391—M. Mengeringhausen
U.S. Pat. No. 3,476,421—M. Tones
U.S. Pat. No. 3,632,147—Julie, Finger
U.S. Pat. No. 3,648,404—C. S. Ogsbury et al.
U.S. Pat. No. 4,493,425—T. Yoshida
U.S. Pat. No. 4,516,376—L. W. King
U.S. Pat. No. 5,421,666—D. L. Spears
U.S. Pat. No. 4,065,890—Wolfgang Fenner
U.S. Pat. No. 4,516,376—Lionel W. King
U.S. Pat. No. 5,061,219—Joel L. Glickman
U.S. Pat. No. 4,922,669—De Pas et al.
U.S. Pat. No. 5,517,928—Anthony E. Erdman
U.S. Pat. No. 4,872,779—K. Imai

1. A structural joint device comprising a cube block for joining rods and panels;
Said joint device having plurality of through cylindrical holes on each X, Y and Z axis;
Said cylindrical thru holes may be arranged in N x N matrix, on each of the three axes of the cube;
Rods of slightly smaller diameter than the holes may be inserted through any of these holes in any or all of the axes;
Panel with mounting hole can be screwed to any of these holes in any or all of the axes

2. A joint device of claim 1, for low strength application made of high tech plastics

3. A joint device of claim 1, for high strength application made of metals

4. A joint device of claim 1, where the holes are configured in 2×2, 3×3,—N×N matrixes

5. A joint device of claim 1, where the holes are threaded to accept machine screws.

6. A joint device of claim 1, where the holes are not threaded, and separate locking screw holes are provided.

7. Structural rods with a diameter slightly smaller than the holes to fit snugly.

8. A joint device of claim 1 that allows joining of three or more rods in three axes without having the rods blocking each others.

9. A joint device of claim 1, where each of the three axis have different numbers of thru holes

10. A joint device of claim 1, where panels can be screwed into any of the holes
